(19) United States
(12) Patent Application Publication
(10) Pub. No.: US 2007/0223614 A1
(43) Pub. Date: Sep. 27, 2007

(54) Common time frequency radio resource in wireless communication systems

(76) Inventors: Ravi Kuchibhotla, Gurnee, IL (US); Robert T. Love, Barrington, IL (US); Kenneth A. Stewart, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 11/387,275

(22) Filed: Mar. 23, 2006

(51) Int. Cl. H04L 1/02

(52) U.S. Cl. 375/267

(57) ABSTRACT

A wireless communication network (100) wherein a network entity assigns one or more symbol vectors to each of a plurality of communication entities in the network for substantially simultaneous communication on a common time frequency radio resource also assigned to the plurality of communication entities. The vectors assigned to the multiple entities may be common or unique or both.

### FIELD OF THE DISCLOSURE

The present disclosure relates generally to wireless communications, and more particularly to wireless communication systems where multiple wireless communication entities are assigned a common time frequency radio resource, and corresponding methods.

### BACKGROUND OF THE DISCLOSURE

In wireless communication systems, it is desirable to reduce overhead associated with signaling for voice and data services, system information, control, etc. In traditional GSM and UMTS systems, bearer establishment is enabled through dedicated signaling. The bearer defines radio parameters, for example, time slot, frequency, code, etc., associated with a channel during a call. In voice communications, for example, a dedicated channel is assigned to each user. In High Speed Downlink Packet Access (HSDPA) systems, transport format and modulation/coding parameters (TFRI) are provided using dedicated control signaling on a shared control channel, wherein the shared control channel also signals the code channel assigned to the user.

In some data only (DO) systems, voice is served over IP (VoIP). It is known to improve such systems for VoIP traffic using hybrid automatic repeat request (HARQ) error correction schemes and smaller packet sizes. While VoIP users have the same benefits of advanced link adaptation and statistical multiplexing as data users, the greatly increased number of users that may be served because of the smaller voice packet sizes places a burden on control and feedback mechanisms of the system. It can be easily envisioned, for example, that 30 times as many voice packets could be served in a given frame than data packets. There are typically about 1500 bytes for data and about 40-50 bytes for voice. Present resource allocation and channel quality feedback and acknowledgment mechanisms however are not designed to handle such a large number of allocations.

In 802.16e systems, it is known to use a telescoping control channel that expands to include as many assignments as necessary for resource allocation. However, such an expansion mechanism does not address feedback or the fact that the entire downlink may be consumed for control information.

The various aspects, features and advantages of the present disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates an exemplary wireless communication system.

FIG. 2 illustrates a wireless communication entity.

FIG. 3 illustrates a process diagram.

FIG. 4 illustrates a time frequency radio resource.

FIG. 5 illustrates a wireless communication network infrastructure entity.

### DETAILED DESCRIPTION

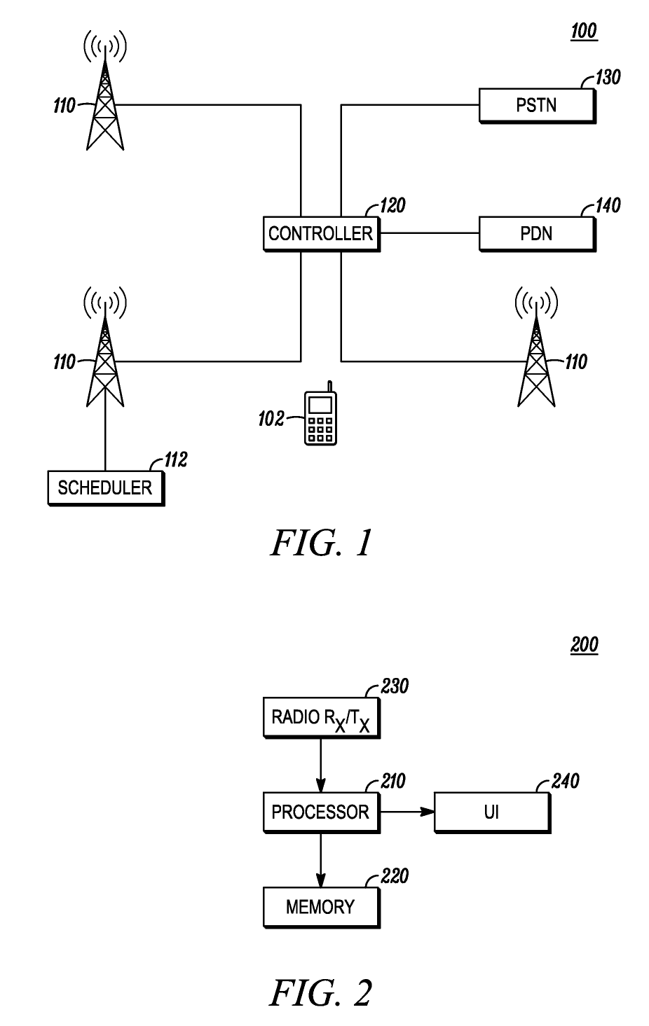

In FIG. 1, the exemplary wireless communication system comprises a cellular network including multiple cell serving base stations 110 distributed over a geographical region. The cell serving base station (BS) or base station transceiver 110 is also commonly referred to as a Node B or cell site wherein each cell site consists of one or more cells, which may also be referred to as sectors. The base stations are communicably interconnected by a controller 120 that is typically coupled via gateways to a public switched telephone network (PSTN) 130 and to a packet data network (PDN) 140. The base stations additionally communicate with mobile terminals 102 also commonly referred to as User Equipment (User Terminal) or wireless user terminals to perform functions such as scheduling the terminals to receive or transmit data using available radio resources. The network also comprises management functionality including data routing, admission control, subscriber billing, terminal authentication, etc., which may be controlled by other network entities, as is known generally by those having ordinary skill in the art.

Exemplary cellular communication networks include 2.5 Generation 3GPP GSM networks, 3rd Generation 3GPP WCDMA networks, and 3GPP2 CDMA communication networks, among other existing and future generation cellular communication networks. Future generation networks include the developing Universal Mobile Telecommunications System (UMTS) networks, and Evolved Universal Terrestrial Radio Access (E-UTRA) networks. The network may also be of a type that implements frequency-domain oriented multi-carrier transmission techniques, such as Frequency Division Multiple Access (OFDM), DFT-Spread-OFDM, IFDMA, etc., which are of interest for future systems. So-called single-carrier based approaches with orthogonal frequency division (SC-FDMA), particularly Interleaved Frequency Division Multiple Access (IFDMA) and its frequency-domain related variant known as DFT-Spread-OFDM (DFT-SOFDM) are attractive in that they optimize performance when assessed using contemporary waveform quality metrics, which may include peak-to-average power ratio (PAPR) or the so-called cubic metric (CM).

In OFDM networks, both Time Division Multiplexing (TDM) and Frequency Division Multiplexing (FDM) are employed to map channel-coded, interleaved and data-modulated information onto OFDM time/frequency symbols. The OFDM symbols can be organized into a number of resource blocks consisting of M consecutive sub-carriers for a number N consecutive OFDM symbols where each symbol may also include a guard interval or cyclic prefix. An OFDM air interface is typically designed to support carriers of different bandwidths, e.g., 5 MHz, 10 MHz, etc. The resource block size in the frequency dimension and the number of available resource blocks are generally dependent on the bandwidth of the system.

In FIG. 2, the exemplary wireless terminal 200 comprises a processor 210 communicably coupled to memory 220, for example, RAM, ROM, etc. A wireless radio transceiver 230 communicates over a wireless interface with the base stations of the network discussed above. The terminal also includes a user interface (UI) 240 including a display, microphone and audio output among other inputs and outputs. The processor may be implemented as a digital controller and/or a digital signal processor (DSP) under control of executable programs stored in memory as is known generally by those having ordinary skill in the art. Wireless user terminals, which are referred to as User Equipment (UE) in WCDMA networks, are also referred to herein as schedulable wireless communication user terminals or entities, as discussed more fully below. Wireless communication entities other than user terminals may also be scheduled.

Generally, a wireless communication network infrastructure scheduling entity located, for example, in a base station 110 in FIG. 1, allocates or assigns radio resources to schedulable wireless communication entities, e.g., mobile terminals or fixed base entities, in the wireless communication network. In FIG. 1, one or more scheduling entities schedule and allocate radio resources to mobile terminals in corresponding cellular areas. In FIG. 1, for example, a scheduler 112 is associated with each base station. In multiple access schemes such as those based on OFDM methods, multi-carrier access or multi-channel CDMA wireless communication protocols including, for example, IEEE-802.16e-2005, multi-carrier HRPD-A in 3GPP2, and the long term evolution of UTRA/UTRAN Study Item in 3GPP (also known as evolved UTRA/UTRAN (EUTRA/EUTRAN)), scheduling may be performed in the time and frequency dimensions using a Frequency Selective (FS) scheduler. To enable FS scheduling by the base station scheduler, in some embodiments, each mobile terminal provides a per frequency band channel quality indicator (CQI) to the scheduler.

In OFDM systems, a resource allocation is the frequency and time allocation that maps information for a particular user terminal to resource blocks as determined by the scheduler. This allocation depends, for example, on a frequency-selective channel-quality indication (CQI) reported by the user terminal to the scheduler. More general allocations may not be limited to symbol and sub-carrier consecutive allocations as described in the context of the resource block above, but may comprise an arbitrary set of sub-carriers located with an arbitrary set of OFDM symbols. The channel-coding rate and the modulation scheme, which may be different for different resource blocks (or more generally, for the symbol-subcarrier allocation) are also determined by the scheduler and may also depend on reported CQI information. If resource blocks are used, a user terminal may not be assigned every sub-carrier in the resource block. It could be assigned every Q-th sub-carrier of a resource block, for example, to improve frequency diversity. Thus a resource assignment can be a resource block or a fraction thereof, or a more general allocation not constrained to lie within a single resource block, but permitted to occupy a general set of symbol-subcarrier locations in time-frequency. Multiplexing of lower-layer control signaling may be based on time, frequency and/or code multiplexing. In what follows, it is understood that a radio resource refers to the arbitrary set Ω of symbol-subcarrier locations, or groupings of such locations, available to one or more transmitting entities to convey a specific transmission.

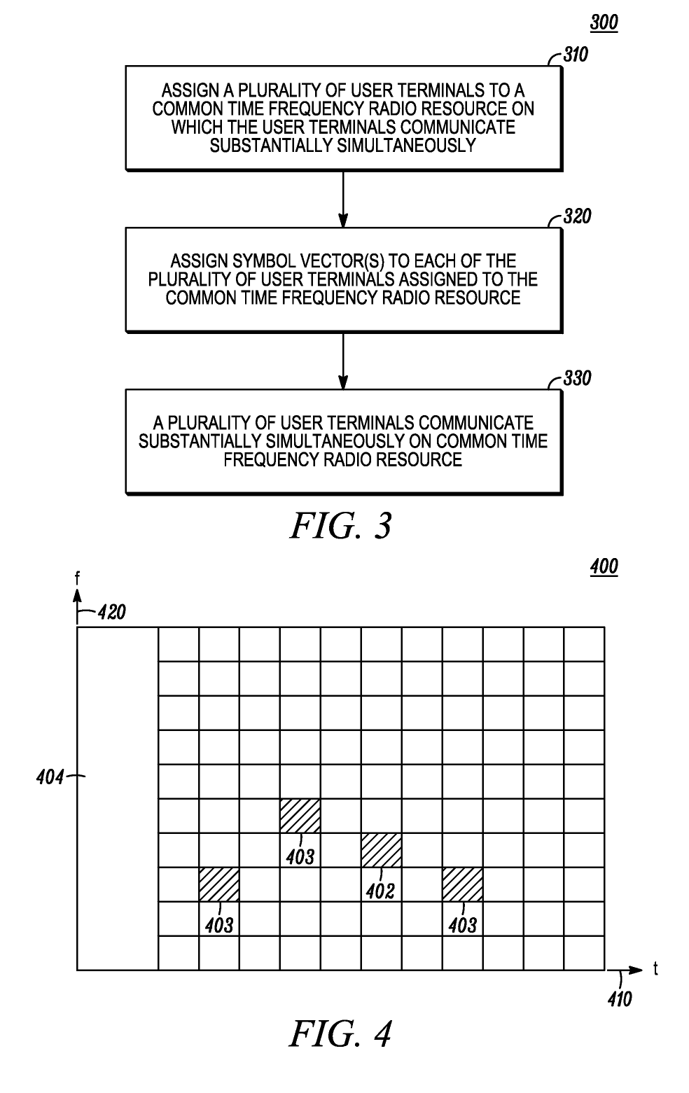

In the process flow diagram 300 of FIG. 3, at 310, a plurality of at least two schedulable wireless entities, for example, user terminals, are assigned a common time frequency radio resource Ω on which the plurality of user terminals may communicate substantially simultaneously. In one embodiment, for example, the common time frequency radio resource is an uplink on which the plurality of user terminals provides feedback information to a base station or other network infrastructure entity. Another use of such a radio resource Ω may include a request for further traffic-bearing radio resources, for example, an indication of the onset of voice activity provided by a speech encoder in response to a user initiating speech. In another example, a base station may transmit a base station or other network identifier over a common downlink radio resource, potentially in response to an uplink mobile station transmission, including a random access attempt. The common radio resource is generally assigned by a scheduler or other entity within the wireless communication network infrastructure. The radio resource assignment may be explicit, i.e., where the scheduler or other entity transmits an explicit identifier describing the radio resource. Alternatively, the radio resource may be implicit, where the radio resource is identified by, for example, the ordering of a transmission to the device accessing the radio resource within a set of transmissions to a plurality of such devices.

In some embodiments, a “substantially simultaneous” action does not require exactly simultaneous operation. For example, user terminals or mobile stations at varying distances from a base station may transmit at slightly different instants in time, as required by a timing-correction or time-advance procedure executed in conjunction with the base station, in order to be observed at the base station receiver in a substantially simultaneous manner. In some applications, for example, in the case of OFDM transmissions, symbol transmissions that are observed time-aligned within the temporal extent of any cyclic extension, e.g., “cyclic prefix” or “cyclic suffix”, of the time-domain OFDM symbol may be viewed for the purposes of receiver signal processing, and the vector detection process described below, as received in a substantially simultaneous fashion.

FIG. 4 illustrates a time frequency radio resource 400. The schematic time frequency resource includes a time dimension 410 and a frequency dimension 420. The assignment of the plurality of user terminals to a common time frequency radio resource means that each user terminal is assigned to the same time and frequency dimensions. In FIG. 4, for example, a plurality of user terminals may be assigned the common time frequency resource 402. In one embodiment, the radio resource assignments are communicated to the plurality of user terminals on a control channel portion 404 of the radio resource. Note, however, that the common time frequency resource might also be non-contiguous, as indicated by allocation 403. Most importantly, the set Ω of time-frequency (or symbol-subcarrier) locations so identified may be ordered (according to a pre-defined rule) by the user terminals to form a symbol vector of quadrature amplitude modulated (QAM) or other modulated symbols.

In FIG. 3, at block 320, one or more symbol vectors are assigned to each of a plurality of wireless communication entities, for example, to a plurality of user terminals, assigned to the common time frequency radio resource. In one embodiment, one or more unique symbol vectors are assigned to each of the plurality of communication entities in the wireless communication network for substantially simultaneous communication on a common time frequency radio resource also assigned to the plurality of communication entities. In another embodiment, a common symbol vector is assigned to each of the plurality of communication entities in the wireless communication network for substantially simultaneous communication on the common time frequency radio resource. In other embodiments both common and unique symbol vectors are assigned to each entity assigned to the common radio resource.

For example, a common symbol vector may be assigned to a plurality of broadcast recipient wireless entities for providing uplink feedback information on a common time frequency radio resource. Other examples are discussed below. The symbol vector may include any QAM modulation type, pilot or other symbols. In some applications, it may be sufficient that the set of symbol vectors assigned to each user are linearly independent. Alternatively, the symbol vectors may be based on any method of orthogonalizing vectors assigned to each user. Note that the vectors so assigned may include the null-vector, for example, an all-zeros vector in the case of QAM modulation.

The symbol vectors are generally assigned by a scheduler or other entity within the wireless communication network infrastructure, though the assignment may be made by other entities. The mapping of the vector to the user terminals may be implied by the order of the user terminals in the group, for example, the first user terminal uses the first vector, and so on. Alternatively, the mapping could be established as users are added to and deleted from the group assigned to the common time frequency radio resource.

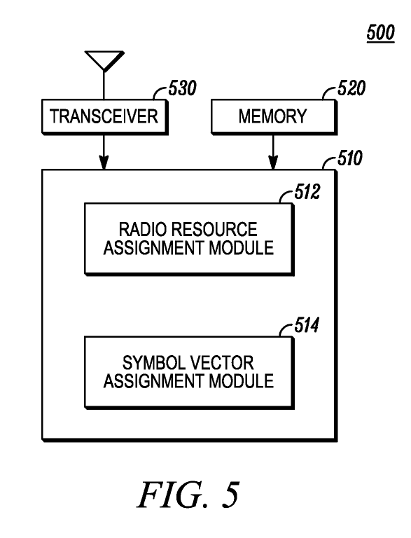

FIG. 5 illustrates a wireless communication network infrastructure entity 500 comprising generally a controller 510 communicably coupled to memory 520 and to a transceiver 530. The entity 500 is typically embodied as part of a base station or Node B and/or a scheduler of a radio access network. The controller includes radio resource assignment module 512 that assigns a common time frequency radio resource to a plurality of wireless communication user terminals communicating in the radio access network. The controller also includes a symbol vector assignment module 514 that assigns a unique symbol vector to each of the plurality of wireless communication user terminals in the wireless communication network, wherein the unique symbol vectors permit the plurality of wireless communication user terminals to communicate substantially simultaneously on the common time frequency radio resource.

Assigning each of the plurality of wireless communication entities permits the plurality of entities to communicate substantially simultaneously on the common time frequency radio resource, as indicated in FIG. 3, at 330. Where the entities have been assigned unique symbol vectors, the communications from the entities are distinguishable.

In the exemplary embodiment, where the common radio resource is a feedback resource, a plurality of user terminals may simultaneously communicate on the common time frequency radio resource using the assigned unique symbol vectors. In one embodiment, the user terminals use the unique symbol vectors to communicate ACK or NACK feedback (or solely ACK or NACK feedback). Generally, the feedback may be indicative of a state of reception of information received by the communication entity providing the feedback. For example, a user terminal may transmit a NACK using the unique symbol vector on the common time frequency radio resource if a packet addressed to the wireless communication entity cannot be properly decoded by the user terminal. This may be especially beneficial in a broadcast channel or multicast channel where a single downlink transmission is intended to be received by a plurality of user devices, and the scheduling entity wishes to be aware that any of the intended user devices failed to receive the downlink transmission. In this case, a common symbol vector is assigned to all the user devices for transmission via the common time-frequency resource in the event of a failure by any user devices to decode the downlink transmission. The base station then detects the common symbol vector as the transmitted symbol vector modified by the sum of the time-frequency channel responses associated with each user terminal. In one embodiment, the base station modifies the encoding rate and/or modulation on a downlink broadcast transmission based on the strength of the aggregate feedback signal. In this case, a non-coherent detector may, for example, be used to provide a means of performing the detection task. In other embodiments, the user terminals use the unique symbols vectors to communicate a channel quality indicator, buffer occupancy state indicator or other information on the common uplink feedback channel.

Consider further the embodiment where a common symbol vector is assigned to each of the plurality of communication entities. As stated previously, the common time-frequency radio resource Ω may be used for the purpose of permitting any of a plurality of user terminals to transmit, say, a negative acknowledgement (NACK) to the base station in response to incorrect reception of frames on a broadcast service, thereby permitting the network to, for example, modify the radiated power level, transmitted information or code rate, or layered encoding structure applied to the frames and codewords broadcast to the plurality of user terminals. If a user terminal receives a particular frame correctly, it makes no transmission on the common time-frequency radio resource Ω. If it receives a frame incorrectly, it transmits the common QAM symbol vector v on the common time-frequency radio resource Ω.

In more detail, consider that in a particular frame, two user terminals receive the frame in error, and transmit the common QAM symbol vector v on the common time-frequency radio resource. The vector y of ordered observations constructed at the base station (BS) receiver over Ω may be expressed as:
y=diag(h₁)v+diag(h₂)v+n (1.1)
where diag(h₁) is a square matrix (of order equal to the length N of the common vector v) whose principal diagonal is comprised of the length-N vector of complex-valued channel coefficients h_{1,n} comprising the frequency-domain multipath channel vector h₁ associated with the first user terminal. n is a vector of noise plus interference. Similarly, diag(h₂) is constructed from the frequency-domain multipath channel vector h₂ associated with the second user terminal.

From equation (1.1), however, it can be readily seen that
y=diag(h₁+h₂)v+n (1.2)
and, by extension, if K user terminals are substantially simultaneously transmitting the NACK vector v then

$$y = diag ( {\sum }_{k = 1}^{K} {h}_{k} ) v + n = diag ( {h}_{c} ) v + n \qquad ( 1.3 )$$

where h_{c} is the composite channel generated from the sum of the active user channels.

Detection of the presence of a NACK transmission from any user terminal can then be accomplished using, for example, a standard hypothesis test designed to discriminate reception (hypothesis H₀) of observation diag(h_{c})v+n or solely the noise vector n (hypothesis H₁). This can be done, for example, by forming the non-coherent decision statistic λ

$$λ = {\sum }_{n = 1}^{N} {\vert {v}_{k}^{*} {y}_{k} \vert}^{2} = \{ \begin{matrix}{\sum }_{n = 1}^{N} {\vert {h}_{k} + {v}_{k}^{*} {n}_{k} \vert}^{2} & {H}_{0} \\ {\sum }_{n = 1}^{N} {\vert {v}_{k}^{*} {n}_{k} \vert}^{2} & {H}_{1}\end{matrix} \qquad ( 1.4 )$$

and then adopting H₀ if, say, λ>T(σ²), that is, if the decision statistic exceeds a threshold T which depends on the interference plus noise variance σ². Classically, T(σ²) is designed to achieve a specified probability of falsely detecting the common vector v (“constant false alarm rate”) or a specified probability of failing to detect v when present etc.

It will likewise be clearly understood that more elaborate hypothesis tests may be based on the observation vector y (which may be further constructed from observations are multiple base station antennas) based on the set of possible vectors v transmitted by the set of users, either in common or individually.

In another embodiment, a plurality of symbol vectors is assigned to at least one of the plurality of communication entities. In this case, the sets of symbol vectors assigned to each communication entity may be disjoint, or may be partially or completely overlapping. In this embodiment, each of the symbol vectors assigned to the one or more user terminals may be used to communicate different information on the common radio resource. For example, one symbol vector may be used for communicating NACK information, and another symbol vector may be used for communicating some other information. According to this embodiment, each user terminal may communicate different types of information on the common radio resource simultaneously with other user terminals.

While the present disclosure and the best modes thereof have been described in a manner establishing possession and enabling those of ordinary skill to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication entity in a wireless communication network, the method comprising:
assigning at least one symbol vector to each of a plurality of communication entities in the wireless communication network for substantially simultaneous communication on a common time frequency radio resource also assigned to the plurality of communication entities.

2. The method of claim 1, receiving feedback on the common time frequency radio resource from a communication entity assigned to the common time frequency radio resource, the feedback indicative of a state of reception of information received by the communication entity providing the feedback.

3. The method of claim 1, receiving a negative acknowledgement on the common time frequency radio resource from a communication entity assigned to the common time frequency radio resource.

4. The method of claim 1, assigning the common time frequency radio resource includes assigning a common feedback channel on which the plurality of communication entities may substantially communicate simultaneously.

5. The method of claim 1, assigning at least one symbol vector includes assigning a unique symbol vector to each of the plurality of communication entities in the wireless communication network for substantially simultaneous communication on a common time frequency radio resource also assigned to the plurality of communication entities.

6. The method of claim 5, receiving, substantially simultaneously, feedback on the common time frequency radio resource from more than one communication entity assigned to the common time frequency radio resource.

7. The method of claim 1, assigning the at least one symbol vector includes assigning a common symbol vector to each of the plurality of communication entities in the wireless communication network for substantially simultaneous communication on a common time frequency radio resource also assigned to the plurality of communication entities.

8. The method of claim 1, assigning a plurality of symbol vectors to at least one of the plurality of communication entities, each of the assigned symbol vectors for providing feedback information from the corresponding communication entity.

9. A wireless communication network infrastructure entity, comprising:
a controller,
the controller configured for assigning a common time frequency radio resource to a plurality of wireless communication terminals,
the controller configured for assigning a symbol vector to each of the plurality of wireless communication entities in the wireless communication network,
wherein the wireless communication entities may communicate substantially simultaneously on the common time frequency radio resource using the assigned symbol vectors.

10. The entity of claim 9, further comprising a transceiver communicably coupled to the controller, the transceiver for communicating the time frequency radio resource assignment and vector symbol assignments to the plurality of user terminals.

11. The entity of claim 10, the transceiver for receiving, substantially simultaneously, feedback on the common time frequency radio resource from more than one communication entity assigned to the common time frequency radio resource.

12. The entity of claim 9, the controller assigning a plurality of unique symbol vectors to at least one of the plurality of communication entities, each of the unique symbol vectors assigned for providing unique feedback information from the corresponding communication entity.

13. The entity of claim 9, the controller configured for assigning a unique symbol vector to each of the plurality of wireless communication entities in the wireless communication network.

14. The entity of claim 9, the controller configured for assigning a common symbol vector to each of the plurality of wireless communication entities in the wireless communication network.

15. A method in a wireless communication terminal capable of communicating in a wireless communication network, the method comprising:
identifying common time frequency radio resource assignment made to the wireless communication terminal;
receiving a symbol vector assignment for communicating on the time frequency radio resource,
the common time frequency resource accommodating substantially simultaneous communication by a plurality of wireless communication terminals using symbol vectors assigned to the plurality of wireless communication terminals.

16. The method of claim 15, receiving the symbol vector assignment includes receiving a unique vector assignment.

17. The method of claim 15, receiving the symbol vector assignment includes receiving an assignment of a vector commonly assigned to more than one wireless communication terminals.

18. The method of claim 15,
receiving the symbol vector assignment includes receiving a NACK assignment,
receiving packet information on the time frequency radio resource,
transmitting a NACK on the common time frequency radio resource if a packet addressed to the wireless communication entity cannot be properly decoded by the wireless communication entity.

19. The method of claim 15, receiving a symbol vector assignment includes receiving an assignment of a plurality of symbol vectors, each of the symbol vectors assigned associated with feedback information.

20. A wireless communication user terminal capable of communicating in a wireless communication network, the entity comprising:
a transceiver;
a controller communicably coupled to the transceiver,
the controller operable to cause the transceiver to transmit a symbol vector assigned to the wireless communication user terminal on a radio resource that is assigned to a plurality of other wireless communication user terminals, each of which is also assigned at least one symbol vector,
the time frequency radio resource assigned to a plurality of wireless communication user terminals for communicating substantially simultaneously.
